(19) United States
(12) Patent Application Publication
(10) Pub. No.: US 2025/0260902 A1
(43) Pub. Date: Aug. 14, 2025

(54) ELECTRONIC DEVICE, CONTROL METHOD FOR ELECTRONIC DEVICE, AND NON-TRANSITORY COMPUTER READABLE MEDIUM

(71) Applicant: CANON KABUSHIKI KAISHA, Tokyo (JP)

(72) Inventor: MASAKI ISHII, Kanagawa (JP)

(21) Appl. No.: 19/051,343

(22) Filed: Feb. 12, 2025

(30) Foreign Application Priority Data
Feb. 14, 2024 (JP) 2024-020178

(51) Int. Cl. H04N 23/74; H04N 23/55

(52) U.S. Cl. CPC H04N 23/74; H04N 23/55

(57) ABSTRACT

An electronic device comprising: a processor; and a memory storing a program which, when executed by the processor, causes the electronic device to: perform acquisition processing to acquire a tally signal indicating one of a plurality of tally lamps, each corresponding to one of a plurality of optical systems in a lens unit of an imaging device; and perform control processing to control lighting of a tally lamp indicated by the tally signal.

### BACKGROUND OF THE INVENTION

### Field of the Invention

The present invention relates to an electronic device, a control method for the electronic device, and a non-transitory computer readable medium.

### Description of the Related Art

In recent years, there has been growing attention on imaging devices used to shoot photographs or moving images that are viewable in three dimensions, as well as display devices used to view virtual reality (VR) images that provide a high level of immersion and realistic sensations. As methods for viewing VR images, a 3D view through a head mounted display (HMD) and a 2D view through a PC monitor or the like are available.

The VR180 format is one of the VR image formats that enable binocular three-dimensional viewing. In imaging devices equipped with a dual lens system for obtaining images in the VR180 format, image regions for the left eye and the right eye are generated. However, when the images in the VR180 format are viewed in 2D, the image region for the left eye is displayed. Therefore, during shooting, it is preferable for the subject's line of sight to align with the lens corresponding to the image region for the left eye. This is to align the line of sight of a viewer viewing the VR180 images in 2D with that of the subject. For this purpose, markers are sometimes applied to the lenses for shooting in order to clearly indicate which lens the subject needs to align their line of sight with.

Furthermore, when shooting performers or the like at a studio, there are cases where a plurality of imaging devices are switched during shooting. In such cases, tally lamps are used to indicate to the subject which imaging device is currently being used and which imaging device the subject needs to align their line of sight with during shooting.

For example, Japanese Patent Application Laid-open No. 2014-7447 discloses a shooting method where a single shooting device is equipped with a plurality of tally lamps. Japanese Patent Application Laid-open No. 2016-33563 discloses a shooting method that uses a plurality of imaging devices equipped with tally lamps.

In a method where markers are applied to lenses for shooting, adding the markers to the lenses becomes cumbersome when using a plurality of imaging devices. Furthermore, when the imaging devices are set up in a dark place for shooting, it is difficult for the subject to visually identify the markers. In the technologies disclosed in Japanese Patent Application No. 2014-7447 and Japanese Patent Application No. 2016-33563, it is possible to indicate to the subject, through the tally lamps, which imaging device the subject needs to align their line of sight with. However, it is not possible to indicate to the subject which lens in a dual lens system the subject needs to align their line of sight with. For VR images captured in such a condition, the line of sight of a viewer may not align with that of the subject when viewing the VR images in 2D.

### SUMMARY OF THE INVENTION

The present invention provides a technology that enables easy capture of VR images where the viewer's line of sight aligns with that of the subject.

An electronic device of the present invention includes: a processor; and a memory storing a program which, when executed by the processor, causes the electronic device to: perform acquisition processing to acquire a tally signal indicating one of a plurality of tally lamps, each corresponding to one of a plurality of optical systems in a lens unit of an imaging device; and perform control processing to control lighting of a tally lamp indicated by the tally signal.

Further features of the present invention will become apparent from the following description of exemplary embodiments with reference to the attached drawings.

### BRIEF DESCRIPTION OF THE DRAWINGS

FIG. 1 is a block diagram showing the configuration of a camera according to a first embodiment;

FIG. 2 is a schematic diagram showing the entire configuration of a system according to the first embodiment;

FIG. 3 is a flowchart showing the operation of the camera according to the first embodiment;

FIG. 4 is a schematic diagram showing the entire configuration of a system according to a second embodiment;

FIG. 5 is a flowchart showing the operation of the camera according to the second embodiment;

FIG. 6 is a block diagram showing the configuration of a camera according to a third embodiment; and

FIG. 7 is a flowchart showing the operation of the camera according to the third embodiment.

### DESCRIPTION OF THE EMBODIMENTS

Hereinafter, embodiments of the present invention will be described in detail with reference to the drawings.

### First Embodiment

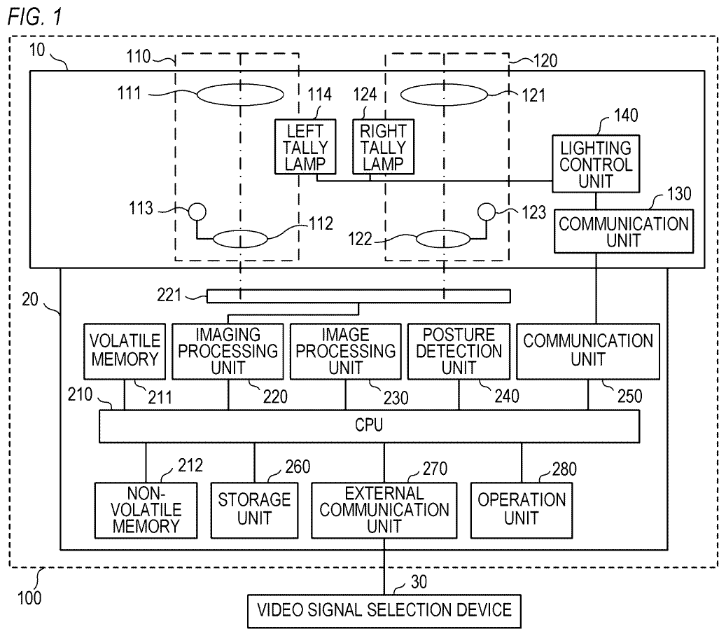

FIG. 1 is a block diagram showing the configuration of a camera (an imaging system or an imaging device) 100 according to a first embodiment. The camera 100 has a lens device (lens unit) 10 and a camera body (camera housing) 20. The camera 100, the lens device 10, and the camera body 20 are examples of the electronic device according to the first embodiment.

The lens device 10 has a left lens group (left optical system) 110, a right lens group (right optical system) 120, a left tally lamp 114, a right tally lamp 124, a communication unit 130, and a lighting control unit 140. The lens device 10 is a type of replaceable lens unit attachable to and detachable form the camera body 20.

Each of the left lens group 110 and the right lens group 120 forms an optical image from incident light and causes an imaging element 221 to receive the formed optical image. As a result, the camera body 20 is capable of forming an image for the left eye and an image for the right eye, and storing these images viewable in three dimensions (3D view). The left lens group 110 has a zoom lens 111, a focus lens 112, and a focus motor 113. The focus motor 113 drives the focus lens 112 to adjust the focus. Similar to the left lens group 110, the right lens group 120 has a zoom lens 121, a focus lens 122, and a focus motor 123. The focus motor 123 drives the focus lens 122 to adjust the focus.

The left tally lamp 114 is a tally lamp that corresponds to the left lens group 110. Furthermore, the right tally lamp 124 is a tally lamp that corresponds to the right lens group 120. The lighting of the left tally lamp 114 and the lighting of the right tally lamp 124 are controlled separately. By providing a plurality of tally lamps, each corresponding to one of a plurality of optical systems in the lens device 10 of the camera 100, it is possible to indicate which lens the subject's line of sight needs to align with during shooting.

The communication unit 130 performs the transmission or reception of control signals and data with the camera body 20. For example, the communication unit 130 receives a tally signal transmitted from the camera body 20. As the communication between the lens device 10 and the camera body 20, mount communication is performed via the electrical contacts between the lens device 10 and the camera body 20. Note that since the shooting sequence is controlled within the camera body 20, the communication between the lens device 10 and the camera body 20 is preferably performed in accordance with the communication protocol of the camera body 20.

The lighting control unit 140 controls the lighting (light emission) of the left tally lamp 114 and the right tally lamp 124 on the basis of the tally signal received via the communication unit 130. The tally signal contains information about a tally lamp intended to light up (information indicating one of a plurality of tally lamps, i.e., selection information). The lighting control unit 140 controls the lighting of the tally lamp indicated by the selection information and the extinguishing of the other tally lamps.

The camera body 20 has a CPU 210, a volatile memory 211, a non-volatile memory 212, an imaging processing unit 220, an image processing unit 230, a posture detection unit 240, a communication unit 250, a storage unit 260, an external communication unit 270, and an operation unit 280.

The CPU 210 is the central processing unit of a microcomputer and controls the entire camera body 20. The CPU 210 is composed of at least one processor and/or at least one circuit. In other words, the CPU 210 may be a processor, a circuit, or a combination thereof. The CPU 210 realizes each processing of the flowcharts described later by executing a program stored in the non-volatile memory 212.

The volatile memory 211 is, for example, a random-access memory (RAM) and is used to temporarily retain data. In the volatile memory 211, constants for operating the CPU 210, variables, a program read from the non-volatile memory 212, and the like are loaded.

The non-volatile memory 212 is, for example, a read only memory (ROM), and constants for operating the CPU 210, a program, and the like are stored in the non-volatile memory 212. Here, the program refers to a program for executing the flowcharts described later.

The imaging element (image sensor) 221 is composed of CCD elements, CMOS elements, or the like. The imaging element 221 receives light from an optical image that has been formed after passing through the lens device 10 and converts the optical image into an electric signal. The imaging processing unit 220 applies A/D conversion to the electric signal (information about charges) output from the imaging element 221 to generate an image signal representing digital data.

The image processing unit 230 performs predetermined processing (such as lens correction, brightness correction, and conversion of image data formats based on distribution destinations) on the image signal generated by the imaging processing unit 220, and then outputs image data after the predetermined processing. The lens correction includes, for example, aberration correction and peripheral light amount correction. The image data formats include VR180 and VR360 formats for network distribution.

The posture detection unit 240 detects the posture of the camera body 20 with respect to the gravity direction. On the basis of the posture detected by the posture detection unit 240, it is possible to determine whether the camera body 20 is set up in a normal position or an upside-down position. As the posture detection unit 240, an acceleration sensor, a gyro sensor, or the like is, for example, usable.

The communication unit 250 performs the transmission or reception of control signals or data with the lens device 10. For example, the communication unit 250 transmits a tally signal to the lens device 10 or receives lens information retained by the lens device 10. The lens information includes lens-inherent information such as lens types, identifiers (IDs) for identifying individuals, and aberration information, as well as shooting information such as zoom magnifications during shooting.

The storage unit 260 stores the image data output from the image processing unit 230. The storage unit 260 may be embedded in the camera body 20, or it may be attachable to and detachable from the camera body 20.

The external communication unit 270 performs the transmission or reception of control signals or data with an external device. For example, the external communication unit 270 receives a tally signal from a video signal selection device 30 or transmits captured image data to the video signal selection device 30. The video signal selection device 30 will be described later.

The operation unit 280 is an input unit that receives operations from a user (shooter) and is used to input various operating instructions to the CPU 210. For example, the user is able to instruct the start of shooting using the operation unit 280.

Here, the lens device 10 is a dual lens unit (VR180 lens unit) used to capture images in the VR180 format, which is one of the virtual reality (VR) image formats that enable binocular three-dimensional viewing. The lens device 10 has a fish-eye lens in each of the right lens group 120 and the left lens group 110, which is capable of capturing a field of view of approximately 180 degrees. Note that the field of view capable of being captured by the lens in each of the right lens group 120 and the left lens group 110 may be narrower than 180 degrees, such as approximately 160 degrees. The lens device 10 is capable of forming a right image formed via the right lens group 120 and a left image formed via the left lens group 110 on one or two imaging elements of the camera body 20 to which the lens device 10 is attached. In the camera body 20, a right image and a left image are formed on one imaging element (imaging sensor), creating one image (binocular image) where a right-image region corresponding to the right image and a left-image region corresponding to the left image are arranged side by side. The binocular image contains the right-image region, the left-image region, and a region (a non-image region, e.g., a black region) not corresponding to an optical image. A right image formed via the right lens group 120 and a left image formed via the left lens group 110 are formed side by side on the imaging unit of the camera body 20. In other words, two optical images are formed on two regions of one imaging element (imaging sensor) by the right lens group 120 and the left lens group 110. The imaging unit converts the formed subject images (light signals) into analog electric signals. By using the lens device 10 (the right lens group 120 and the left lens group 110) as described above, it is possible to capture one image (binocular image) containing two image regions with parallax relative to each other. When the captured image is divided into an image for the left eye and an image for the right eye and is then displayed in VR, the user is enabled to view a three-dimensional VR image with a field of view of approximately 180 degrees. In other words, the user is enabled to view the image in the VR180 format in three dimensions.

Here, the VR image refers to an image capable of being displayed in VR as described later. The VR image includes omnidirectional images (celestial sphere images) captured by an omnidirectional camera (celestial sphere camera), panoramic images with a video range (effective video range) wider than the display range capable of being displayed on a display unit at once, and the like. Furthermore, the VR image is not limited to still images but also includes moving images and live images (images captured from the camera in almost real time). The VR image has a video range (effective video range) with a visual field of 360 degrees in the left-and-right direction and a visual field of 360 degrees in the top-and-bottom direction at maximum. Furthermore, the VR image also includes images captured at view angles wider than those of typical cameras, even if the view angles cover less than 360 degrees in the left-and-right direction and 360 degrees in the top-and-bottom direction. Alternatively, the VR image also includes images with video ranges that exceed the display ranges displayable on the display unit at once. Images captured by the camera body 20 using the lens device 10 described above are a type of the VR image. The VR image is capable of being displayed in VR, for example, by setting the display mode of the display device (display device capable of displaying the VR image) to “VR view.” By displaying a part of the VR image with a view angle of 360 degrees and changing the posture of the display device in the left-and-right direction (horizontal rotation direction), it is possible for the user to move the display range and view an omnidirectional video seamless in the left-and-right direction.

The VR display (VR view) refers to a display method (display mode) that displays, as a VR image, video within a visual field corresponding to the posture of the display device and enables a display range to be changed. The VR display includes a “monocular VR display (monocular VR view)” where a VR image is transformed (distortion correction) to be mapped onto a virtual sphere to display one image. Furthermore, the VR display includes a “binocular VR display (binocular VR view)” where a VR image for the left eye and a VR image for the right eye are transformed to be mapped onto a virtual sphere and are displayed side by side in left and right regions. By performing the “binocular VR display” using the VR image for the left eye and the VR image for the right eye with parallax relative to each other, it is possible to view the VR images in three dimensions. For example, when the user wears a display device such as a head-mounted display (HMD), video within the visual field corresponding to the orientation of the user's face is displayed in both the monocular VR display and the binocular VR display. For example, it is assumed that the video within a visual field centered at 0 degrees in the left-and-right direction (in a specific direction, for example, the north) and 90 degrees in the top-and-bottom direction (90 degrees from the zenith, that is, the horizontal level) at a certain time point is displayed as a VR image. When the posture of the display device is turned inside out (for example, when the orientation of the display surface is changed from the south to the north) from this state, the display range is adjusted so that the video within the visual field centered at 180 degrees (in the opposite direction, for example, the south) in the left-and-right direction and 90 degrees in the top-and-bottom direction is displayed as the same VR image. In other words, when the user turns the face from the north to the south (that is, when the user looks back) while wearing the HMD, the video displayed on the HMD also changes from video in the north to video in the south. Note that the VR image captured using the lens device 10 is an image (180° image) obtained by capturing the range of approximately 180 degrees in a forward direction and does not include the video within the range of approximately 180 degrees in a backward direction. When such an image is displayed in VR and the posture of the display device is changed to a side where video does not exist, a blank region is displayed.

When the VR image is displayed in VR as described above, the user is enabled to obtain a feeling (a sense of immersion) as if he/she were visually present in the VR image (VR space). Note that the method for displaying the VR image is not limited to changing the posture of the display device. For example, the display range may be moved (scrolled) according to user operations via a touch panel, a direction button, or the like. Furthermore, during the VR display (display mode “VR view”), the display range may be moved according to touch-move on the touch panel, drug operations with a mouse or the like, pressing of the direction button, or the like, in addition to changing the display range on the basis of changes in posture. Note that a smartphone attached to VR goggles (a head-mounted adapter) is a type of HMD.

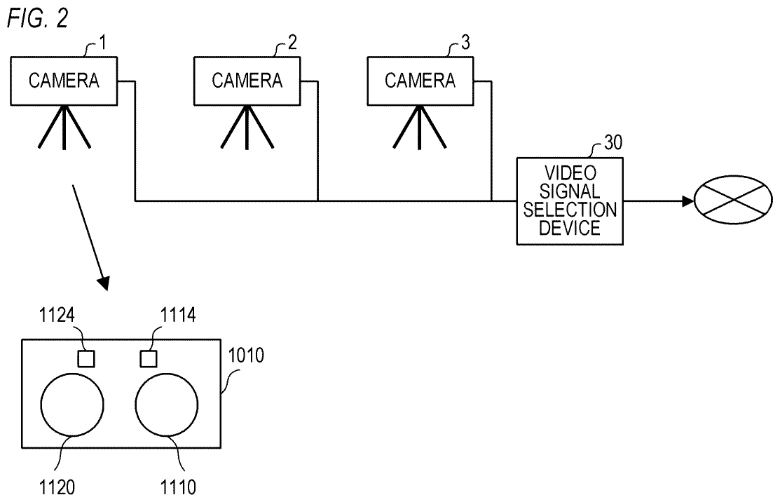

FIG. 2 is a schematic diagram showing an example of the entire configuration of a system according to the first embodiment. FIG. 2 shows an example where cameras 1, 2, and 3 mounted on tripods are connected to the video signal selection device 30. The cameras 1, 2, and 3 are examples of the camera 100.

Furthermore, FIG. 2 also shows a schematic diagram of a lens device 1010 of the camera 1 when viewed from the subject side. The lens device 1010 is an example of the lens device 10. When the lens device 1010 is viewed from the subject side, a left lens group 1110 and a left tally lamp 1114 corresponding to the left lens group 1110 are arranged on the right side of the lens device 1010. On the left side of the lens device 1010, a right lens group 1120 and a right tally lamp 1124 corresponding to the right lens group 1120 are arranged. Although not shown in FIG. 2, lens groups and tally lamps are arranged in the lens devices of the cameras 2 and 3 in the same manner as the camera 1.

The cameras 1, 2, and 3 convert captured video into video in the VR180 format that is an image data format for distribution, and transmit the converted video to the video signal selection device 30. The video signal selection device 30 selects a camera from among the cameras 1, 2, and 3 to shoot video for distribution. The video signal selection device 30 transmits a tally-on signal to the camera that will shoot video for distribution and a tally-off signal to the other cameras, thereby switching the video to be distributed. Note that the video signal selection device 30 may convert the format of the video shot by the cameras 1, 2, and 3 into an image data format for distribution.

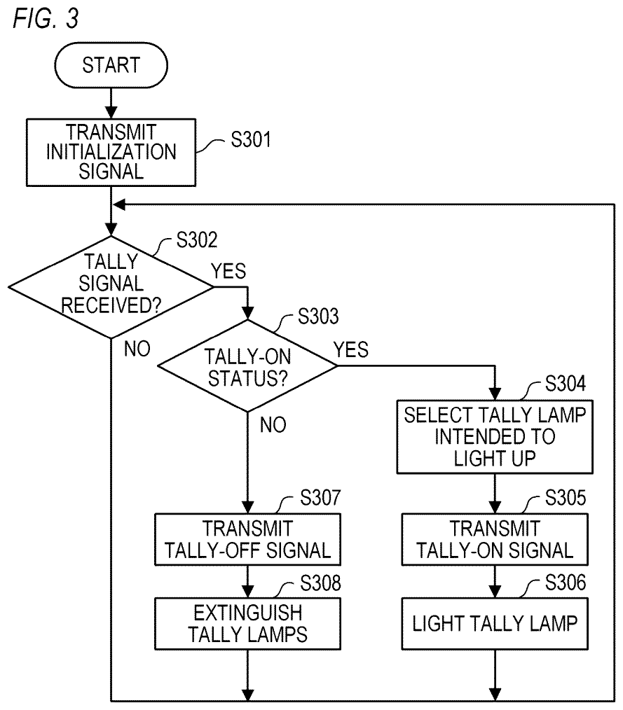

FIG. 3 is a flowchart showing an example of the operation of the camera 1 (an example of the camera 100). This operation is realized when the CPU 210 loads the program stored in the non-volatile memory 212 into the volatile memory 211 and executes the same. For example, the operation shown in FIG. 3 starts when the power of the camera 1 is turned on and a connection to the video signal selection device 30 is established.

In step S301, the CPU 210 transmits an initialization signal to the lens device 10 (the lighting control unit 140) to initialize the lighting states of the tally lamps. The lighting control unit 140 extinguishes all the tally lamps (the left tally lamp 1114 and the right tally lamp 1124) of the camera 1.

In step S302, the CPU 210 determines whether a tally signal has been received from the video signal selection device 30 after starting shooting. When the tally signal has been received, the CPU 210 proceeds to step S303. Otherwise, the CPU 210 remains on standby until the tally signal has been received. Note that image data output from the image processing unit 230 is transmitted to the video signal selection device 30 via the external communication unit 270 while the CPU 210 remains on standby for the tally signal.

In step S303, the CPU 210 determines whether the received tally signal indicates a tally-on or tally-off status. When the received tally signal indicates the tally-on status, the CPU 210 proceeds to step S304. Otherwise, the CPU 210 proceeds to step S307.

In step S304, the CPU 210 selects a tally lamp intended to light up from among the tally lamps arranged in the lens device 1010.

Here, in the camera 1 equipped with the lens device 1010 (a lens unit for capturing images in VR180 format), an image is generated where a right image region captured via the right lens group 1120 and a left image region captured via the left lens group 1110 are arranged side by side. For viewing this image, a 2D view that displays one of the plurality of image regions (the right and left image regions) is available. In the 2D view for images in VR180 format, the image region for the left eye in a 3D view is displayed. When the camera 1 is set up in a normal position as shown in FIG. 2, the image region corresponding to the image region for the left eye is the left image region captured via the left lens group 1110. Accordingly, in step S304, the CPU 210 selects the left tally lamp 1114, which corresponds to the left lens group 1110, as the tally lamp intended to light up. Thus, it is possible to indicate to the subject to align (direct) their line of sight with the left lens group 1110 during shooting (imaging). As a result, it becomes easier to capture VR images where the line of sight of a viewer in 2D view aligns with that of the subject.

The left tally lamp 1114 and the right tally lamp 1124 may be arranged in such a manner that the subject understands their corresponding relationships with the left lens group 1110 and the right lens group 1120. For example, in FIG. 2, the left tally lamp 1114 is arranged on the upper side of the left lens group 1110, and the right tally lamp 1124 is arranged on the upper side of the right lens group 1120. Note that each tally lamp may be arranged, for example, on the lower side of a corresponding lens group. Furthermore, as shown in FIG. 2, the left tally lamp 1114 and the right tally lamp 1124 are preferably arranged at positions closer to the center of the lens device 1010. For example, if the left tally lamp 1114 is positioned closer to the outside of the lens device 1010, the subject's line of sight is likely to be directed toward that position during the lighting of the left tally lamp 1114. In such a condition, the viewer's line of sight aligns with the subject's line of sight in a 2D view that displays the left image region, but it may not align with the subject's line of sight in a 3D view that displays both the right image region and the left image region. Accordingly, by arranging each tally lamp at a position closer to the center of the lens device 1010, it is possible to indicate to the subject to align their line of sight to that position and easily capture VR images where the viewer's line of sight aligns with the subject's line of sight in both the 2D and the 3D views.

Referring back to FIG. 3, in step S305, the CPU 210 (the communication unit 250) transmits a tally-on signal containing information (selection information) about the tally lamp selected in step S304 to the lens device 1010 (the communication unit 130). The lens device 1010 receives the tally-on signal containing the selection information.

In step S306, the lighting control unit 140 controls the lighting of the tally lamp indicated by the tally-on signal received in step S305.

In the processing of steps S304 to S306, a tally signal indicating the tally lamp corresponding to the optical system associated with a predetermined image region among a plurality of image regions, each captured via one of a plurality of optical systems, is transmitted and received between the camera body 20 and the lens device 1010. The predetermined image region refers to, for example, an image region for the left eye. The lighting control unit 140 lights the left tally lamp 1114 corresponding to the optical system associated with the image region for the left eye and extinguishes the right tally lamp 1124 corresponding to the optical system associated with the image region for the right eye.

In step S307, the CPU 210 (the communication unit 250) transmits a tally-off signal to the lens device 1010 (the communication unit 130). The lens device 1010 receives the tally-off signal.

In step S308, the lighting control unit 140 controls the extinguishing of all the tally lamps (the left tally lamp 1114 and the right tally lamp 1124) of the camera 1 on the basis of the tally-off signal received in step S307.

Note that in the above example, the CPU 210 receives the tally signal transmitted from the video signal selection device 30. However, the CPU 210 may also perform control, assuming that a tally-on signal has been received when a shooting instruction is provided by the shooter (user). For example, the CPU 210 may transmit a tally-on signal to the lens device 1010 upon receiving a shooting instruction through a half-pressing operation of the shooting button on the operation unit 280.

Furthermore, a shooting system is provided where the lens device 1010 is attachable to and detachable from the camera body 20. The present invention is not limited to this system but is also applicable to imaging devices where the camera body and the lens device are configured integrally.

As described above, in the first embodiment, a plurality of tally lamps, each corresponding to one of the plurality of lens groups in the lens device of the camera are provided, and the tally lamp corresponding to the lens group that captures the image region displayed in a 2D view is caused to light up. Thus, it is possible to indicate to the subject which lens the subject needs to align their line of sight with during the shooting of VR images and to easily capture VR images where the viewer's line of sight in the 2D view aligns with that of the subject.

### Second Embodiment

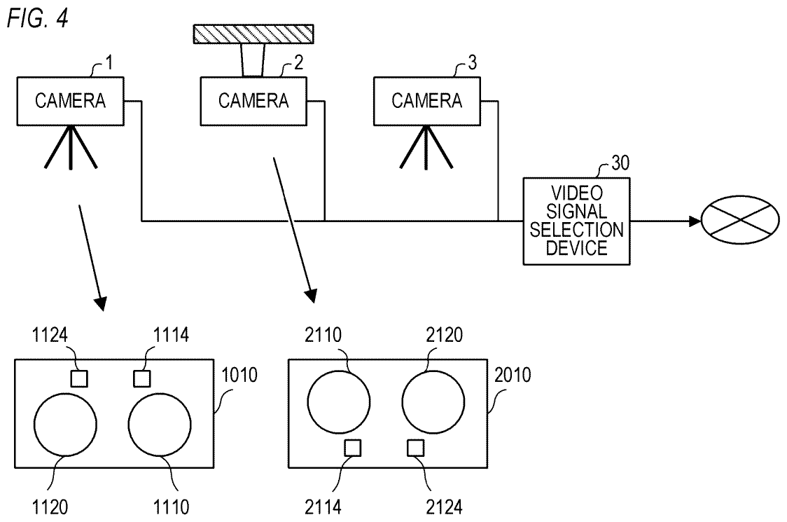

FIG. 4 is a schematic diagram showing an example of the entire configuration of a system according to a second embodiment. The first and second embodiments are the same in that the plurality of cameras 1, 2, and 3 are connected to the video signal selection device 30. The second embodiment differs from the first embodiment in that, while all the cameras 1, 2, and 3 are set up in a normal position in the first embodiment, the camera 2 is set up in an inverted (upside-down) position on the ceiling in the second embodiment. FIG. 4 also shows a schematic diagram of the cameras 1 and 2 when viewed from the subject side.

When the lens device 1010 of the camera 1 set up in a normal position is viewed from the subject side, the left lens group 1110 and the left tally lamp 1114 corresponding to the left lens group 1110 are arranged on the right side of the lens device 1010. On the left side of the lens device 1010, the right lens group 1120 and the right tally lamp 1124 corresponding to the right lens group 1120 are arranged.

When a lens device 2010 of the camera 2 set up in an inverted position is viewed from the subject side, a right lens group 2120 and a right tally lamp 2124 corresponding to the right lens group 2120 are arranged on the right side of the lens device 2010. On the left side of the lens device 2010, a left lens group 2110 and a left tally lamp 2114 corresponding to the left lens group 2110 are arranged.

As described above, the positions of the lens groups and the tally lamps of the camera 1 are reversed left and right compared to those of the camera 2 when viewed from the subject side of the cameras 1 and 2. For viewing an image in the VR180 format, zenith correction (processing to correct the orientation of the image so that the zenith direction becomes downward and the nadir direction becomes upward) is performed. Therefore, the lens group that captures the image region for the left eye, which is the image region displayed when viewing an image in the VR180 format in 2D, varies according to the posture of the camera. For example, the left lens group 1110 is used in the camera 1, while the right lens group 2120 is used in the camera 2. Accordingly, in the second embodiment, a tally lamp intended to light up changes according to the posture of the camera.

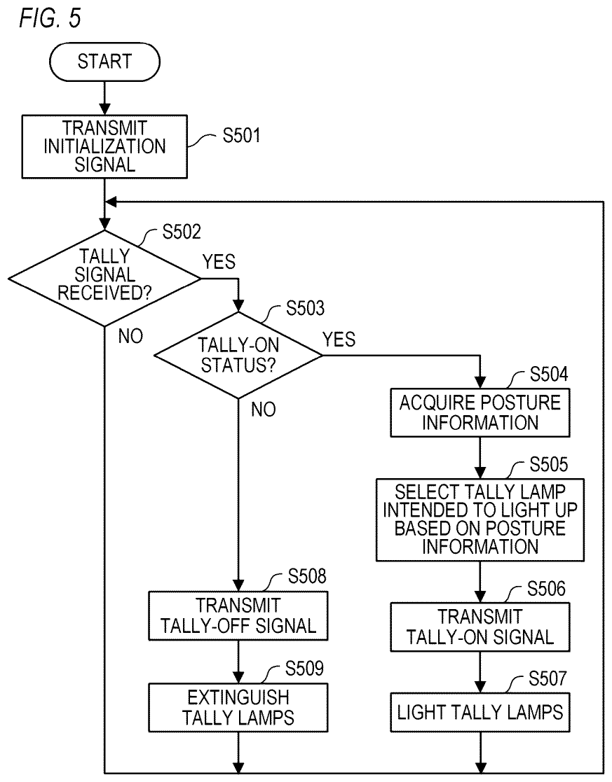

FIG. 5 is a flowchart showing an example of the operation of the camera 2 (an example of the camera 100). The processing of steps S501 to S503 and steps S506 to S509 is the same as that of steps S301 to S303 and steps S305 to S308 in FIG. 3. Note that in the following description of the flowchart shown in FIG. 5, the CPU 210 of the camera 2 will be described as an example.

In step S504, the CPU 210 acquires posture information indicating the posture of the camera 2 from the detection result of the posture detection unit 240. For example, the CPU 210 determines whether the camera 2 is set up in a normal or inverted position using a gyro sensor or an acceleration sensor embedded in the body of the camera 2. When the camera 2 is set up in an inverted position as shown in FIG. 4, the CPU 210 acquires posture information indicating the inverted position.

In step S505, the CPU 210 selects a tally lamp intended to light up from among the tally lamps arranged in the lens device 2010 on the basis of the posture information acquired in step S504.

Here, for a VR image captured in the inverted position, the image region for the left eye is displayed in a 2D view, similar to a VR image captured in the normal position. When the camera 2 is set up in the inverted position as shown in FIG. 4, an image region corresponding to the image region for the left eye is captured via the right lens group 2120. Therefore, the subject's line of sight is preferably directed toward the right lens group 2120 during shooting (imaging). Accordingly, when the posture information indicating the inverted position is acquired in step S504, the CPU 210 selects the right tally lamp 2124 corresponding to the right lens group 2120 as the tally lamp intended to light up in step S505. Note that when the posture information indicating the normal position is acquired in step S504, the CPU 210 selects the left tally lamp 2114 corresponding to the left lens group 2110 as the tally lamp intended to light up in step S505.

In the processing of steps S504 to S507, a tally signal indicating the tally lamp, which varies according to the posture of the camera (the electronic device), is transmitted and received between the camera body 20 and the lens device 1010. In conventional methods that use a marker to indicate which lens the subject needs to align their line of sight with, the marker must be reapplied to the other lens if the camera is inverted. However, it is possible to shoot VR images without the need for such labor.

As described above, in the second embodiment, a tally lamp intended to light up changes according to the posture of the camera. Thus, even when the lens with which the subject needs to align their line of sight varies according to the posture of the camera, it is possible to easily indicate to the subject which lens the subject needs to align their line of sight with during the shooting of VR images and to easily capture VR images where the viewer's line of sight aligns with that of the subject.

### Third Embodiment

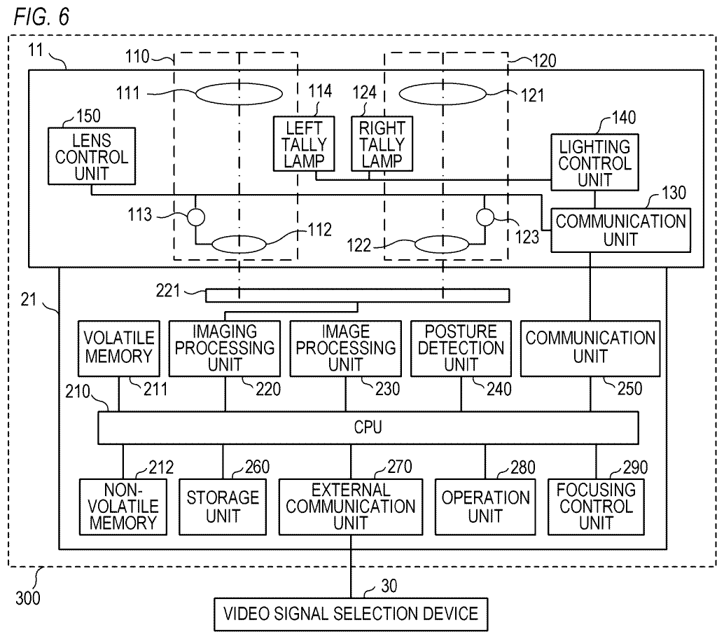

FIG. 6 is a block diagram showing the configuration of a camera 300 according to a third embodiment. The camera 300 has a lens device 11 and a camera body 21. Hereinafter, the points that differ from the configuration of the camera 100 according to the first embodiment (FIG. 1) will be primarily described.

The camera body 21 has a focusing control unit 290 in addition to the configuration of the camera body 20 of the camera 100. The focusing control unit 290 generates a lens driving signal to adjust the focus. Furthermore, the lens device 11 has a lens control unit 150 in addition to the configuration of the lens device 10 of the camera 100. The lens control unit 150 controls the focus motors 113 and 123 on the basis of the lens driving signal received via the communication unit 130 and drives the focus lenses 112 and 122.

In recent years, cameras have been equipped with a function that automatically detects the eyes of people or animals and adjusts (or continuously adjusts) focus to the positions of the eyes in images, which is referred to as eye autofocus or the like. When eye autofocus is applied during the shooting of VR images, it is possible to more reliably adjust focus to the positions of the eyes in the images by using the image region aligned with the subject's line of sight. Accordingly, in the third embodiment, when a tally-on signal is received, focus is adjusted using the image region corresponding to the tally lamp that lights up.

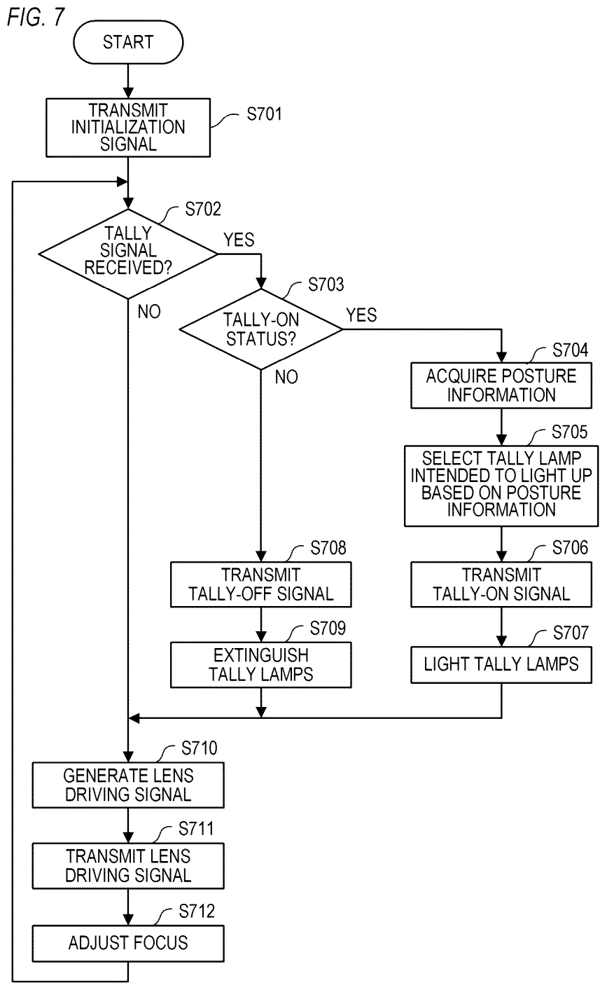

FIG. 7 is a flowchart showing an example of the operation of the camera 300. The processing of steps S701 to S709 is the same as that of steps S501 to S509 in FIG. 5.

In step S710, the CPU 210 (the focusing control unit 290) generates a lens driving signal to adjust the focus of the left lens group 110 and the right lens group 120. First, the CPU 210 determines whether to calculate a defocus amount representing the deviation of the focus using the image region (left image region) captured via the left lens group 110 or the image region (right image region) captured via the right lens group 120.

When the tally-on signal has been received (YES in S703), the CPU 210 calculates the defocus amount using the image region captured via the lens group corresponding to the tally lamp selected in step S705 (the tally lamp intended to light up). When the tally-on signal has not been received (NO in S702 or NO in S703), the CPU 210 calculates the defocus amount using the left image region. Note that the image region used when the tally-on signal has not been received may be determined in advance, and the right image region may also be used. The CPU 210 calculates the driving amounts of the focus lenses 112 and 122 on the basis of the calculated defocus amount. Then, the CPU 210 generates a lens driving signal containing the calculated driving amounts (lens driving amounts).

In step S711, the CPU 210 (the communication unit 250) transmits the lens driving signal to the lens device 10 (the communication unit 130). The lens device 10 receives the lens driving signal.

In step S712, the lens control unit 150 drives the focus lenses 112 and 122 on the basis of the lens driving amounts contained in the lens driving signal received in step S711 to adjust focus.

As described above, in the third embodiment, the focus of a plurality of lens groups is adjusted using the image region captured via the lens group corresponding to the tally lamp that lights up. Thus, it becomes easier to capture VR images that are focused on the eyes of the subject.

Furthermore, the embodiments of the present invention have been described in detail above. However, the present invention is not limited to these specific embodiments and includes various other modes without departing from the gist thereof. Moreover, each of the embodiments described above represents only one embodiment, and the embodiments may be appropriately combined.

For example, it is described that one image is acquired where two image regions with parallax relative to each other are arranged side by side. However, the number of image regions, that is, the number of optical systems may be more than two, and the arrangement of a plurality of image regions is not particularly limited.

Furthermore, the present invention is not limited to cameras or PCs but is applicable to any electronic device capable of handling images that contain a plurality of image regions, each corresponding to one of a plurality of optical systems. For example, the present invention is applicable to PDAs, mobile phone terminals, portable image viewers, printers, digital photo frames, music players, video game consoles, eBook readers, cloud servers, and the like. Furthermore, the present invention is applicable to video players, display devices (including projectors), tablet terminals, smartphones, AI speakers, home appliances, in-vehicle devices, and the like. The present invention is also applicable to multi-lens smartphones that have a plurality of different types of optical systems, such as standard lenses, wide-angle lenses, and zoom lenses.

The present invention enables easy capture of VR images where the viewer's line of sight aligns with that of the subject.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-020178, filed on Feb. 14, 2024, which is hereby incorporated by reference herein in its entirety.

What is claimed is:

1. An electronic device comprising:
a processor; and
a memory storing a program which, when executed by the processor, causes the electronic device to:
perform acquisition processing to acquire a tally signal indicating one of a plurality of tally lamps, each corresponding to one of a plurality of optical systems in a lens unit of an imaging device; and
perform control processing to control lighting of a tally lamp indicated by the tally signal.

2. The electronic device according to claim 1, wherein
the electronic device is the lens unit attachable to and detachable from the imaging device, and
in the acquisition processing, the tally signal is received from the imaging device.

3. The electronic device according to claim 1, wherein
the electronic device is the imaging device, and
in the control processing, the tally signal is controlled to be transmitted to the lens unit attached to the imaging device.

4. The electronic device according to claim 1, wherein
the tally signal indicates the tally lamp corresponding to an optical system associated with a predetermined image region among a plurality of image regions, each captured via one of the plurality of optical systems.

5. The electronic device according to claim 4, wherein
a 2D view that displays one of the plurality of image regions is available for viewing the plurality of image regions, and
the predetermined image region is an image region displayed in the 2D view.

6. The electronic device according to claim 4, wherein
the plurality of image regions include an image region for a right eye and an image region for a left eye, and
the predetermined image region is the image region for the left eye.

7. The electronic device according to claim 1, wherein
in the acquisition processing, the tally signal is acquired in a case where a shooting instruction is provided by a user.

8. The electronic device according to claim 1, wherein
the tally signal indicates a tally lamp that varies according to a posture of the electronic device.

9. The electronic device according to claim 1, wherein
further in the control processing, focus adjustment of the plurality of optical systems is controlled using an image region captured via an optical system corresponding to a tally lamp that lights up.

10. An electronic device comprising:
a plurality of optical systems, each capturing one of a plurality of image regions; and
a plurality of tally lamps, each corresponding to one of the plurality of optical systems.

11. A control method for an electronic device, comprising:
a step of acquiring a tally signal indicating one of a plurality of tally lamps, each corresponding to one of a plurality of optical systems in a lens unit of an imaging device; and
a step of controlling lighting of a tally lamp indicated by the tally signal.

12. A non-transitory computer readable medium that stores a program, wherein the program causes a computer to execute the control method for the electronic device, the control method comprising:
a step of acquiring a tally signal indicating one of a plurality of tally lamps, each corresponding to one of a plurality of optical systems in a lens unit of an imaging device; and
a step of controlling lighting of a tally lamp indicated by the tally signal.
